(19) United States
(12) Patent Application Publication
(10) Pub. No.: US 2016/0090053 A1
(43) Pub. Date: Mar. 31, 2016

(54) TERMINAL BOX FOR ELECTRIC VEHICLE MOUNTED WITH IN-WHEEL MOTOR

(71) Applicant: Yazaki Corporation, Tokyo (JP)

(72) Inventors: Hajime KATO, Kakegawa-shi (JP); Miki NAKAMURA, Kakegawa-shi (JP); Takeshi INNAN, Kakegawa-shi (JP)

(73) Assignee: Yazaki Corporation, Tokyo (JP)

(21) Appl. No.: 14/964,840

(22) Filed: Dec. 10, 2015

Related U.S. Application Data
(63) Continuation of application No. PCT/JP2014/068486, filed on Jul. 10, 2014.

(30) Foreign Application Priority Data
Jul. 12, 2013 (JP) 2013-146962

(51) Int. Cl. B60R 16/023

(52) U.S. Cl. CPC B60R 16/0238

(57) ABSTRACT

In a terminal box for an electric vehicle mounted with an in-wheel motor, at least a part of a terminal block is housed inside a casing. The terminal body includes a box body and a removable cover. The box body includes openings provided in its bottom portion and top portion. The cover covers the top portion-side opening of the box body. The terminal box is attached to an outer surface of the casing such that the bottom portion opening side of the box body covers the terminal block from above.

### CROSS REFERENCE TO RELATED APPLICATION(S)

This application is a continuation of PCT application No. PCT/JP2014/068486, which was filed on Jul. 10, 2014 based on Japanese Patent Application (No. 2013-146962) filed on Jul. 12, 2013, the contents of which are incorporated herein by reference.

### BACKGROUND OF THE INVENTION

1. Field of the Invention

The present invention relates to a terminal box for an electric vehicle mounted with an in-wheel motor.

2. Description of the Related Art

<Role of Terminal Box>

An in-wheel motor is an electric motor mounted internally in a hub of a wheel of an electric car etc. The in-wheel motor includes a casing, a stator and a rotor. The casing has a circularly cylindrical cavity. The stator is provided in an inner surface of a circumferential wall of the circularly cylindrical cavity. The rotor is provided in an internal space of the stator so as to be rotatable through a slight gap with the stator.

A terminal box is provided on an outer side of the casing in order to supply electric power from a battery to the in-wheel motor. In the terminal box, electric connection is completed when in-wheel motor-side terminals and power line-side terminals are fastened to each other with bolts respectively. Thus, electric power can be supplied from the battery to the in-wheel motor.

<Configuration of Casing 300>

FIG. 4A is a plan view according to JP-A-2009-219271, in which a terminal box is provided on an outer side of a casing of an in-wheel motor. FIG. 4B is a sectional view taken along a line of arrows B4-B4 of FIG. 4A.

In FIG. 4A, a casing 300 is constituted by a circularly cylindrical casing body 300H, disk-like wall faces 300C, and bolts 300B. The disk-like wall faces 300C close opposite end openings of the circularly cylindrical casing body 300H (only the wall face 300C farther from an output-side rotary member is illustrated in the drawing). The casing body 300H and the wall faces 300C are fastened to each other with the bolts 300B.

<Inside Casing 300>

In FIG. 4B, an in-wheel motor (a stator 40 and a rotor 50) and a reduction portion (not shown) are retained in the casing 300. The in-wheel motor drives and rotates a motor-side rotary member 300R. The reduction portion reduces rotation speed of the motor-side rotary member 300R and transmits the reduced rotation speed of the motor-side rotary member 300R to the output-side rotary member.

A bearing 300J which supports the motor-side rotary member 300R in the center of the disk-like wall face 300C rotatably is housed in the disk-like wall face 300C, and through holes 300L through which in-wheel motor-side terminals pass in a thickness direction are formed at predetermined places radially from the center of the disk-like wall face 300C. Incidentally, the reference symbol 300K means a lubricating oil passage.

A terminal box 100 which will be described next is disposed on an outer side of the wall face 300C of the casing 300.

<Terminal Box 100 According to JP-A-2009-219271>

In FIG. 4B, the terminal box 100 is disposed on the outer side of the wall face 300C of the casing 300. The terminal box 100 includes a box body 100H and a cover 100C which closes the box body 100H.

<Box Body 100H>

The box body 100H is a metal rectangular parallelepiped which is short of a bottom portion and one side wall portion. The bottom portion side of the box body 100H is placed to face the through holes 300L of the disk-like wall face 300C, and fastened to the wall face 300C with bolts 100B1.

A side surface portion of the box body 100H short of the side wall portion is covered with the cover 100C.

<Cover 100C>

The cover 100C is a metal plate which is shaped like a rectangle and which closes a rectangular opening portion of the box body 100H. The cover 100C is fastened to the box body 100H with bolts 100B2.

Power line through holes 100W are formed in a side wall portion 100S opposed to the side surface portion of the box body 100H covered with the cover 100C. Power lines W and distal ends of shielding cases S shielding the circumferences of the power lines W are inserted into the power line through holes 100W. Flanges SF of the shielding cases S are fastened to the box body 100H with bolts 100B3.

In an internal space of the box body 100H, power line-side terminals Tw which are electrically connected to distal ends of the power lines W from a battery side, and in-wheel motor-side terminals Tm which are electrically connected to a winding of a motor portion are jointly fastened to each other with bolts 20B respectively.

According to the aforementioned configuration, the terminal box 100 is attached to the wall face 300C farther from the output-side rotary member whose vibration is comparatively small. Accordingly, it is possible to prevent cracks from being generated in coatings of the power lines W due to vibration or it is possible to prevent plugs from coming off. As a result, it is possible to obtain a motor driving device which is excellent in safety and high in reliability.

### SUMMARY OF THE INVENTION

### Problems Inherent in Terminal Box 100 According to JP-A-2009-219271

However, the cover 100C of the terminal box 100 is located on a radial side of the disk-like wall face 300C. Accordingly, whenever electric wire attachment and detachment work is performed, the cover 100C has to be removed in order to gain access to fastening portions between the power line-side terminals Tw and the in-wheel motor-side terminals Tm respectively. Therefore, the electric wire attachment and detachment work is work performed from the radial direction. Accordingly, there is a fear that the wheel attached to the vehicle may become an obstacle to deteriorate working efficiency. Therefore, it is necessary to remove the wheel from the vehicle in order to improve the working efficiency.

In addition, the in-wheel motor-side terminals Tm are not supported, i.e. free from any support member, part of the way from the in-wheel motor side to the fastening portions to the power line-side terminals Tw through the through holes 300L of the wall surface 300C. For this reason, there is a fear that the in-wheel motor-side terminals Tm may be bent and broken due to strong vibration of the in-wheel motor.

The invention has been accomplished in order to solve the foregoing problems. An object of the invention is to provide a terminal box in which working efficiency for electric wire attachment and detachment work can be improved even without removing a wheel and terminals can be prevented from being bent and broken due to strong vibration.

The above-described object can be achieved by the terminal box for an electric vehicle mounted with an in-wheel motor having the following configurations (1)-(4).

(1) A terminal box for an electric vehicle mounted with an in-wheel motor, which is attached to an outer surface of a casing housing the in-wheel motor and in which an in-wheel motor-side terminal and a power line-side terminal are internally fastened to each other with a bolt, wherein at least a part of a terminal block is housed inside the casing, wherein the terminal box includes: a box body which has openings provided in its bottom portion and top portion; and a removable cover which covers a top portion-side opening of the box body, and wherein the terminal box is attached to the outer surface of the casing such that a bottom portion opening side of the box body covers the terminal block from above.

(2) The terminal box for an electric vehicle mounted with an in-wheel motor according to the configuration (1), wherein a power line through hole through which a power line from a battery side is inserted is provided in one side wall portion of the box body, and wherein the power line-side terminal at a distal end of the power line inserted from the battery side through the power line through hole and the in-wheel motor-side terminal from an in-wheel motor side are fastened to each other with the bolt in an upper surface of the terminal block inside the box body.

(3) The terminal box for an electric vehicle mounted with an in-wheel motor according to the configuration (2), wherein in the terminal block, a recess having a depth corresponding to a terminal thickness enough to house the in-wheel motor-side terminal is provided in at least a top portion of the terminal block.

(4) The terminal box for an electric vehicle mounted with an in-wheel motor according to the configuration (2) or (3), wherein a recess having a depth corresponding to a terminal thickness enough to house the in-wheel motor-side terminal is provided in at least one of a bottom portion and a side wall of the terminal block.

As described above, according to the aforementioned configuration (1), when the cover of the terminal box is merely removed, it is possible to gain access to the terminal block from the top portion opening and the bottom portion opening of the box body. Therefore, it is possible to perform electric wire attachment and detachment work even without removing the wheel so that it is possible to improve the working efficiency.

According to the aforementioned configuration (2), the power line-side terminal and the in-wheel motor-side terminal are fastened to each other with a bolt in the upper surface of the terminal block. Therefore, the fastening direction with the bolt is consistent with the access direction to the terminal block from the opening portions of the terminal box so that workability is excellent.

According to the aforementioned configuration (3), the recess whose depth corresponds to the terminal thickness enough to house the in-wheel motor-side terminal is provided in at least the top portion of the terminal block. Therefore, when the in-wheel motor-side terminal is housed in the recess, the terminal can be prevented from being bent and broken due to strong vibration.

According to the aforementioned configuration (4), the in-wheel motor-side terminal is housed also in the recess in at least one of the bottom portion and the side wall of the terminal block. Therefore, movement of the in-wheel motor-side terminal can be further restricted so that the terminal can be more securely prevented from being bent and broken.

The invention has been described above briefly. Further, when a mode (hereinafter referred to as “embodiment”) for carrying out the invention which will be described below is read through with reference to the accompanying drawings, details of the invention can be made further clear.

### BRIEF DESCRIPTION OF THE DRAWINGS

FIG. 1A is a plan view of a terminal box according to the invention, which is provided on an outer side of a casing of an in-wheel motor.

FIG. 1B is a sectional view taken along a line of arrows A-A of FIG. 1A.

FIG. 2 is an enlarged view of an elliptical portion Z2 in FIG. 1B.

FIG. 3A is an exploded perspective view showing a terminal block and tetragonal nuts and in-wheel motor-side terminals which are housed in the terminal block.

FIG. 3B shows a diagram (1) showing a front view of the terminal block of FIG. 3A, and a diagram (2) showing a sectional view taken along a line of arrows B3-B3 of Diagram (1) of FIG. 3B.

FIG. 4A is a plan view of a terminal box according to JP-A-2009-219271.

FIG. 4B is a sectional view taken along a line of arrows B4-B4 of FIG. 4A.

### DETAILED DESCRIPTION OF THE EXEMPLARY EMBODIMENTS

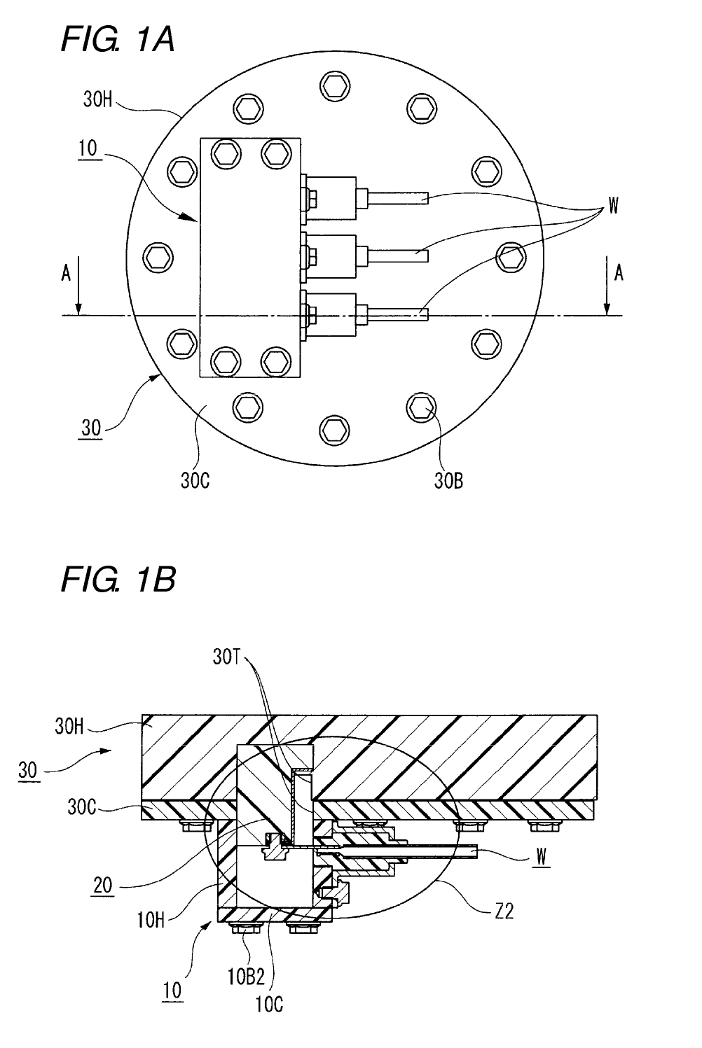

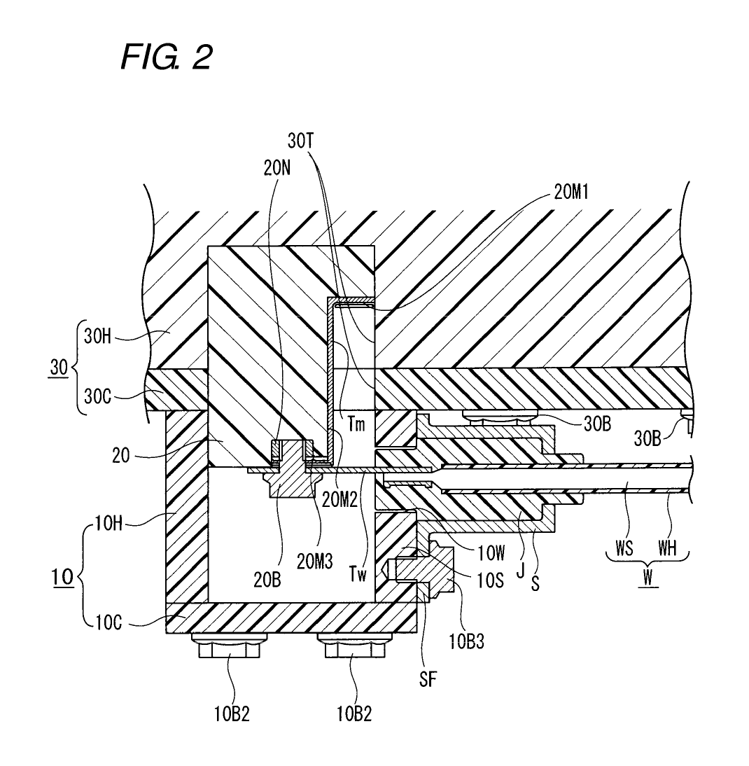

A terminal box according to the invention, in which efficiency for electric wire attachment and detachment work can be improved even without removing a wheel and terminals can be prevented from being bent and broken due to strong vibration, will be described below with reference to FIG. 1A to FIG. 2.

<Casing 30 according to Embodiment>

In FIG. 1A, a casing 30 is constituted by a circularly cylindrical casing body 30H, two disk-like wall faces 30C, and bolts 30B. The two wall faces 30C (only the wall face 30C farther from an output-side rotary member is illustrated in the drawing) close opposite end openings of the circularly cylindrical casing body 30H respectively. The casing body 30H is fastened to the wall faces 30C with the bolts 30B. Thus, a terminal box 10 is disposed on an outer side of the wall face 30C which is the farther one of the two wall faces from the output-side rotary member. Therefore, the terminal box 10 is so far from the vibrating source that vibration can be hardly transmitted to the terminal box 10.

A terminal block housing hole 30T (see FIG. 1B) for housing a terminal block 20 (see FIG. 1B) which will be described next is formed in both the wall face 30C side (see FIG. 1B) of the casing body 30H and the wall face 30C (see FIG. 1B).

<Terminal Block 20>

The terminal block 20 is provided according to the embodiment. The terminal block 20 is an insulating resin block substantially shaped like a rectangular parallelepiped for electrically connecting power line-side terminals of distal ends of power lines W from a battery side and in-wheel motor-side terminals to each other respectively. The in-wheel motor-side terminals are electrically connected to a winding of a motor portion.

In FIG. 2, the terminal block 20 according to the embodiment is embedded in the terminal block housing hole 30T so that a top portion (an upper surface) of the terminal block 20 is exposed to the outside from the casing body 30H and the wall face 30C. In this manner, at least a part of the terminal block 20 is housed inside the casing 30.

Recesses (grooves) whose depths correspond to terminal thicknesses enough to house in-wheel motor-side terminals Tm are provided to extend from a bottom portion 20D to a top portion 20C via a side wall 20S.

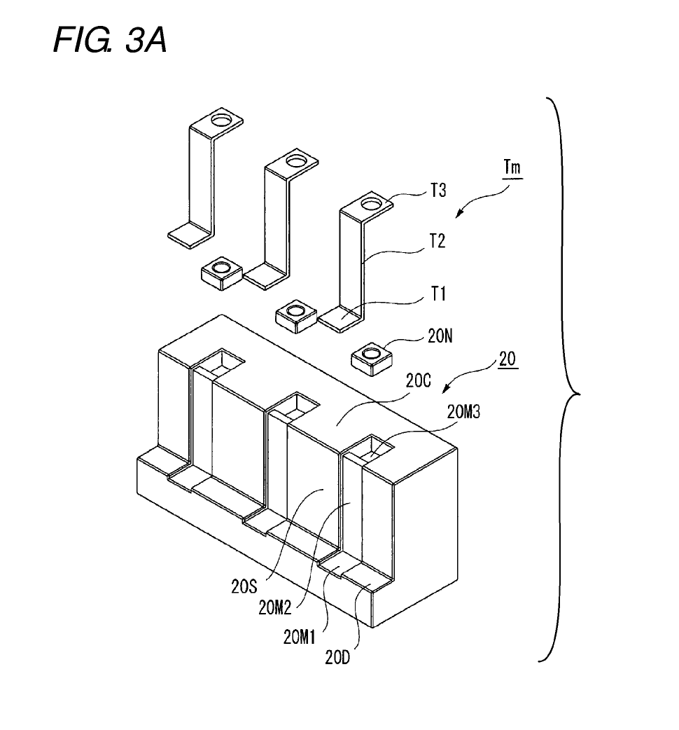

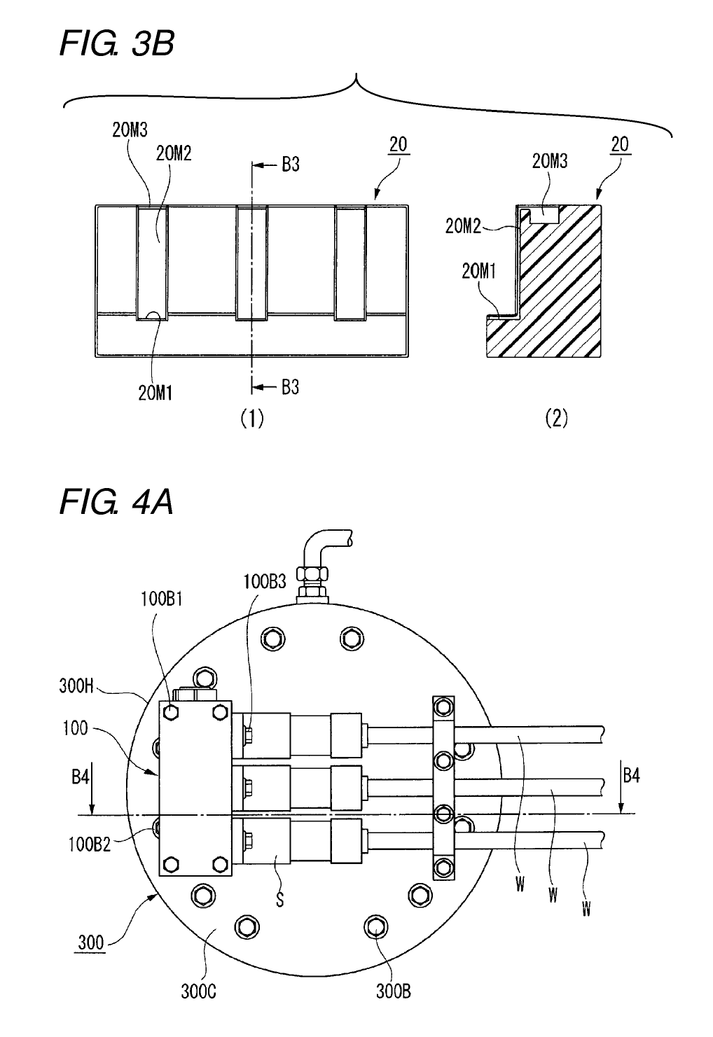

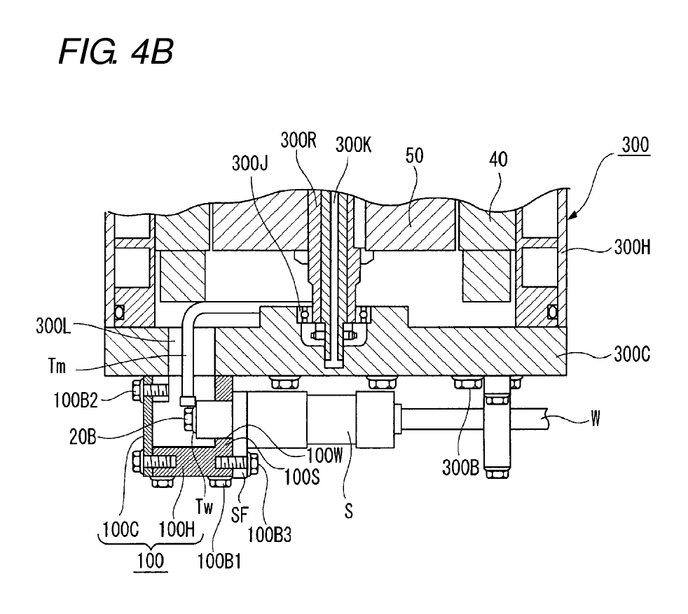

In a perspective view of FIG. 3A, each recess 20M1 is formed in the bottom portion 20D of the terminal block 20. Each recess 20M2 is formed in the side wall 20S of the terminal block 20. Each recess 20M3 is formed in the top portion 20C of the terminal block 20. These recesses 20M1, 20M2 and 20M3 are formed to be connected to one another.

On the other hand, each in-wheel motor-side terminal Tm is substantially bent into a Z-shape as in FIG. 3A. The in-wheel motor-side terminal Tm includes a bottom horizontal portion T1, a vertical connection portion T2 and a top horizontal portion T3.

The bottom horizontal portion T1, the vertical connection portion T2 and the top horizontal portion T3 of the Z-shaped in-wheel motor-side terminal Tm are housed in the recesses 20M1, 20M2 and 20M3 of the terminal block 20 respectively. Therefore, even when strong vibration occurs in an in-wheel motor, movements of the in-wheel motor-side terminals Tm are restricted inside the three places of the recesses 20M1 to 20M3. Accordingly, the in-wheel motor-side terminals Tm can be prevented from being bent and broken.

Tetragonal nuts 20N are embedded in the top portion 20C of the terminal block 20.

The terminal box 10 which will be described next is attached so as to cover the terminal block 20 from above.

<Terminal Box 10>

In FIG. 2, the terminal box 10 according to the embodiment includes a box body 10H, a cover 10C, and bolts 10B2. The cover 10C closes the box body 10H. The box body 10H and the cover 10C are fastened to each other with the bolts 10B2.

<Box Body 10H>

The box body 10H is formed into a metal rectangular parallelepiped (i.e. tetragonal cylinder) which is short of a bottom portion and a top portion. The box body 10H is put and attached to the wall face 30C so that the bottom portion-side opening of the box body 10H can cover the terminal block 20. The top portion-side opening of the box body 10H is covered with the cover 10C and fastened with the bolts 10B2.

Power line through holes 10W are formed in a side wall portion (one side wall portion) 10S of the box body 10H.

Power line-side terminals Tw caulked in distal ends of power lines W are inserted into the power line through holes 10W. Incidentally, each power line W includes a core wire WS and a coating portion WH. The core wire WS is located in the axial center of the power line W. The coating portion WH covers the core wire WS. One end of the power line W is connected to the battery side (not shown). A connector J made of an insulating resin is molded and covered with a shielding case S in the vicinity of the other end of the power line W. A flange SF of the shielding case S is fastened to the side wall portion 10S of the box body 10H with a bolt 10B3.

In an internal space of the box body 10H, the top portion 20C of the terminal block 20 is exposed from the wall face 30C. The in-wheel motor-side terminals Tm and the power line-side terminals Tw of the distal ends of the power lines W from the battery side are jointly fastened to the tetragonal nuts 20N with bolts 20B. The in-wheel motor-side terminals Tm are embedded in the recesses 20M3 of the top portion 20C of the terminal block 20.

Thus, the power line-side terminals Tw and the in-wheel motor-side terminals Tm are fastened with the bolts and electrically connected in the upper surface of the terminal block 20 inside the box body 10H so that electric power can be supplied from the battery to the in-wheel motor.

<Cover 10C>

The cover 10C is a metal plate which is shaped like a rectangle and which closes the other end opening portion of the box body 10H formed into a tetragonal cylinder. The cover 10C is fastened to the box body 10H with the bolts 10B2. As apparent from FIG. 2, the cover 10C is located right above the terminal block 20. Accordingly, when the cover 10C is merely removed, access can be gained to the bolts 20B with which the in-wheel motor-side terminals Tm and the power line-side terminals Tw are fastened to each other respectively. In addition, the wheel attached to the vehicle is provided not in the access direction to the bolts 20B. Therefore, the wheel is not an obstacle so that electric wire attachment and detachment work can be performed even without removing the wheel from the vehicle.

As described above, access to the bolts 20B in the respective terminal fastening portions can be gained from a vertical direction of the two disk-like wall faces 30C (not from a radial direction of the disk-like wall faces 30C as in JP-A-2009-219271). Accordingly, electric wire attachment and detachment work can be performed regardless of the size of the wheel without removing the wheel. Thus, the working efficiency can be improved. Further, a fastening direction with each bolt 20B is consistent with the access direction to the terminal block 20 from each opening portion which appears when the cover 10C of the terminal box 10 is removed. Accordingly, workability is excellent.

Incidentally, the aforementioned embodiment has been described on the assumption that the box body 10H is a tetragonal cylinder which is short of a bottom portion and a top portion. However, the box body according to the invention is not limited to the tetragonal cylinder but may be a triangular cylinder or a circular cylinder.

In addition, the box body 10H does not have to be short of the bottom portion and the top portion but may have the bottom portion and the top portion partially opened.

In addition, the in-wheel motor-side terminals Tm are disposed along the insides of the recesses 20M1, 20M2 and 20M3 of the terminal block 20. Accordingly, the in-wheel motor-side terminals Tm are strong against vibration so that breakage such as bending of the terminals can hardly occur.

### SUMMARY

According to the terminal box 10 for the electric vehicle mounted with the in-wheel motor according to the embodiment, access to the respective terminal fastening portions can be gained from the vertical direction of the two disk-like wall faces 30C. Accordingly, electric wire attachment and detachment work can be performed regardless of the size of the wheel without removing the wheel. Thus, working efficiency can be improved.

The fastening direction with each bolt 20B is consistent with the access direction to the terminal block 20 from each opening portion of the terminal box 10. Accordingly, workability is excellent.

The in-wheel motor-side terminals Tm are disposed along the insides of the recesses 20M1, 20M2 and 20M3 of the terminal block 20. Accordingly, the in-wheel motor-side terminals Tm are strong against vibration so that breakage such as bending of the terminals can hardly occur.

Here, the aforementioned characteristics of the embodiment of the terminal box for the electric vehicle mounted with the in-wheel motor according to the invention will be summarized briefly in the following (1) to (4).

(1) A terminal box (10) for an electric vehicle mounted with an in-wheel motor, which is attached to an outer surface of a casing (30) housing the in-wheel motor and in which an in-wheel motor-side terminal (Tm) and a power line-side terminal (Tw) are internally fastened to each other with a bolt,

wherein at least a part of a terminal block (20) is housed inside the casing (30),

wherein the terminal box (10) includes:
a box body (10H) which has openings provided in its bottom portion (20D) and top portion (20C); and
a removable cover (10C) which covers a top portion-side opening of the box body (10H), and

wherein the terminal box (10) is attached to the outer surface of the casing (30) such that a bottom portion opening side of the box body (10H) covers the terminal block (20) from above.

(2) The terminal box (10) for an electric vehicle mounted with an in-wheel motor according to the aforementioned (1),

wherein a power line through hole (10W) through which a power line (W) from a battery side is inserted is provided in one side wall portion (side wall portion 10S) of the box body (10H), and

wherein the power line-side terminal (Tw) at a distal end of the power line (W) inserted from the battery side through the power line through hole (10W) and the in-wheel motor-side terminal (Tm) from the in-wheel motor side are fastened to each other with the bolt in an upper surface of the terminal block (20) inside the box body (10H).

(3) The terminal box (10) for an electric vehicle mounted with an in-wheel motor according to the aforementioned (2),

wherein a recess (20M1) which has a depth corresponding to a terminal thickness enough to house the in-wheel motor-side terminal (Tm) is provided in at least a top portion (20C) of the terminal block (20).

(4) The terminal box (10) for an electric vehicle mounted with an in-wheel motor according to the aforementioned configuration (2) or (3),

wherein a recess (20M2, 20M3) which has a depth corresponding to a terminal thickness enough to house the in-wheel motor-side terminal (Tm) is provided in at least one of a bottom portion (20D) and a side wall (20S) of the terminal block (20).

Incidentally, the invention is not limited to the aforementioned embodiment but may be carried out with modification, improvement, etc. made thereon suitably. In addition thereto, the materials, the shapes, the dimensions, the numbers, the arrangement places, etc. of the respective constituent elements in the aforementioned embodiment are not limited but may be set desirably as long as the invention can be achieved.

According to the terminal box for the electric vehicle mounted with the in-wheel motor according to the invention, access to the terminal block can be gained from the top portion opening and the bottom portion opening of the box body when the cover of the terminal box is merely removed. Therefore, it is possible to provide a terminal box for an electric vehicle mounted with an in-wheel motor in which electric wire attachment and detachment work can be performed even without removing a wheel so that working efficiency can be improved.

What is claimed is:

1. A terminal box for an electric vehicle mounted with an in-wheel motor, which is attached to an outer surface of a casing housing the in-wheel motor and in which an in-wheel motor-side terminal and a power line-side terminal are internally fastened to each other with a bolt,
wherein at least a part of a terminal block is housed inside the casing,
wherein the terminal box comprises:
a box body which has openings provided in its bottom portion and top portion; and
a removable cover which covers a top portion-side opening of the box body, and
wherein the terminal box is attached to the outer surface of the casing such that a bottom portion opening side of the box body covers the terminal block from above.

2. The terminal box for an electric vehicle mounted with an in-wheel motor according to claim 1,
wherein a power line through hole through which a power line from a battery side is inserted is provided in one side wall portion of the box body, and
wherein the power line-side terminal at a distal end of the power line inserted from the battery side through the power line through hole and the in-wheel motor-side terminal from an in-wheel motor side are fastened to each other with the bolt in an upper surface of the terminal block inside the box body.

3. The terminal box for an electric vehicle mounted with an in-wheel motor according to claim 2,
wherein in the terminal block, a recess having a depth corresponding to a terminal thickness enough to house the in-wheel motor-side terminal is provided in at least a top portion of the terminal block.

4. The terminal box for an electric vehicle mounted with an in-wheel motor according to claim 2,
wherein a recess having a depth corresponding to a terminal thickness enough to house the in-wheel motor-side terminal is provided in at least one of a bottom portion and a side wall of the terminal block.
